(19) United States
(12) Patent Application Publication
(10) Pub. No.: US 2023/0305468 A1
(43) Pub. Date: Sep. 28, 2023

(54) CONTROL METHOD OF IMAGE FORMING APPARATUS AND IMAGE FORMING APPARATUS

(71) Applicant: KYOCERA Document Solutions Inc., Osaka (JP)

(72) Inventors: Yohei Wakasa, Osaka (JP); Sadanori Nakae, Osaka (JP)

(21) Appl. No.: 18/187,548

(22) Filed: Mar. 21, 2023

(30) Foreign Application Priority Data
Mar. 22, 2022 (JP) 2022-045308

(51) Int. Cl. G03G 15/00; G03G 21/00; G03G 21/10; G03G 15/16

(52) U.S. Cl. CPC G03G 15/5054; G03G 21/0058; G03G 21/10; G03G 15/1605; G03G 2215/00059

(57) ABSTRACT

A processor acquires an output image density which is a density detected for a first toner image. The processor causes a cleaning portion to perform toner recovery processing when a second toner image passes through a recovery member. The processor causes a transfer portion to execute primary transfer processing for toner on a target area on the surface of a photoconductor where the second toner image was formed. The processor acquires a remaining toner density which is a density detected for an area on the surface of an intermediate transfer member corresponding to the target area. The processor compares the output image density with the remaining toner density to derive an index value of toner recovery performance of the recovery member.

### INCORPORATION BY REFERENCE

This application is based upon and claims the benefit of priority from the corresponding Japanese Patent Application No. 2022-045308 filed on Mar. 22, 2022, the entire contents of which are incorporated herein by reference.

### BACKGROUND

The present invention relates to a control method of an image forming apparatus capable of evaluating the performance of a cleaning portion for recovering remaining toner from the surface of a photoconductor.

An electrophotographic image forming apparatus forms a toner image on the surface of a photoconductor, and transfers the toner image from the photoconductor to a sheet. The image forming apparatus includes a cleaning portion for recovering remaining toner from the surface of the photoconductor.

The cleaning portion may include a recovery member and a recovery voltage output portion. The recovery member is disposed in contact with the surface of the photoconductor and can retain toner. For example, the recovery member is a porous member such as a sponge.

The recovery voltage output portion can apply a recovery bias voltage or a release bias voltage to the recovery member. The recovery bias voltage is a bias voltage having a polarity different from the charge polarity of the toner. The release bias voltage is a bias voltage having the same polarity as the charge polarity of the toner.

When the recovery bias voltage is applied to the recovery member, toner remaining on the surface of the photoconductor is electrically attracted to the recovery member. The attracted toner is retained in the recovery member.

As toner is accumulated in the recovery member, the toner recovery performance of the recovery member is deteriorated.

On the other hand, when the release bias voltage is applied to the recovery member, toner retained in the recovery member is released to the photoconductor. Thus, the toner recovery performance of the recovery member is improved.

The toner released from the recovery member is carried on the photoconductor and recovered by a developing device.

### SUMMARY

A method according to one aspect of the present invention is a control method of an image forming apparatus. The image forming apparatus comprises an image forming portion, a transfer portion, a cleaning portion, and a density detection portion. The image forming portion includes a rotary photoconductor and is capable of forming a toner image on a surface of the photoconductor. The transfer portion includes a rotary intermediate transfer member and is capable of executing primary transfer processing for transferring the toner image on the surface of the photoconductor to a surface of the intermediate transfer member at a primary transfer position and secondary transfer processing for transferring the toner image on the surface of the intermediate transfer member to a sheet at a secondary transfer position. The cleaning portion is capable of executing toner recovery processing for recovering toner present on a portion of the surface of the photoconductor that has passed through the primary transfer position. The density detection portion detects a density of the toner image on the intermediate transfer member. The cleaning portion includes a recovery member and a recovery voltage output portion. The recovery member rotates while being in contact with the surface of the photoconductor and is capable of retaining the toner. The recovery voltage output portion applies a recovery bias voltage having a polarity different from a charge polarity of the toner to the recovery member in the toner recovery processing. The control method comprises causing, by a processor, the image forming portion to execute first image output processing for forming a first toner image on the surface of the photoconductor. The control method further comprises causing, the processor, the transfer portion to execute the primary transfer processing for the first toner image. The control method further comprises acquiring, by the processor, an output image density that is a density detected by the density detector for the first toner image. The control method further comprises causing, by the processor, the image forming portion to execute second image output processing for forming a second toner image identical to the first toner image on the surface of the photoconductor. The control method further comprises causing, by the processor, the transfer portion to execute non-transfer processing in which the second toner image is not transferred to the intermediate transfer member. The control method further comprises causing, by the processor, the cleaning portion to execute the toner recovery processing when the second toner image passes through the recovery member. The control method further comprises causing, by the processor, the transfer portion to execute the primary transfer processing for toner on a target area on the surface of the photoconductor where the second toner image was formed. The control method further comprises acquiring, by the processor, a remaining toner density that is a density detected by the density detector for the toner on an area on the surface of the intermediate transfer member corresponding to the target area. The control method further comprises deriving, by the processor, an index value of toner recovery performance of the recovery member by comparing the output image density with the remaining toner density.

An image forming apparatus according to another aspect of the present invention comprises the image forming portion, the transfer portion, the cleaning portion, the density detection portion, and the processor for realizing the control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a block diagram showing a configuration of a control device in the image forming apparatus according to the embodiment.

FIG. 3 is a flowchart showing an example of the procedure of toner recovery adjustment processing in the image forming apparatus according to the embodiment.

FIG. 4 is a flowchart showing an example of the procedure of parameter adjustment processing in the image forming apparatus according to the embodiment.

FIG. 5 is a graph showing the relationship between the test image density and the remaining toner density under three measurement conditions relating to the number of prints and a control parameter in the image forming apparatus.

### DETAILED DESCRIPTION

Hereinafter, an embodiment of the present invention will be described with reference to the drawings. It is noted that the following embodiment is an example of embodying the present invention and does not limit the technical scope of the present invention.

An image forming apparatus 10 according to the embodiment is an apparatus that executes print processing using an electrophotographic method. The print processing is processing for forming an image on a sheet 9. The sheet 9 is an image forming medium such as paper or a sheet-like resin member.

[Configuration of Image Forming Apparatus 10]

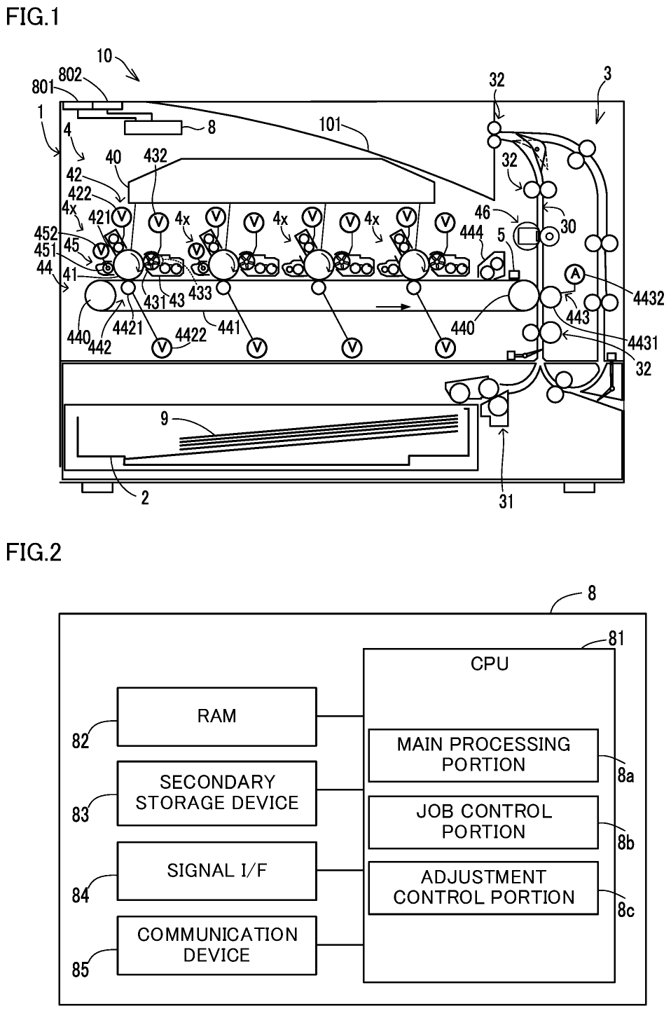

As shown in FIG. 1, the image forming apparatus 10 includes a sheet storing portion 2, a sheet conveying path 30, a sheet conveying device 3, and a printing device 4. Further, the image forming apparatus 10 also includes an operation device 801, a display device 802, and a control device 8.

The sheet conveying path 30, the sheet conveying device 3, the printing device 4, and the control device 8 are housed in a housing 1.

The sheet storing portion 2 houses a sheet 9. The sheet conveying device 3 feeds a sheet 9 from the sheet storing portion 2 to the sheet conveying path 30, and further conveys the sheet 9 along the sheet conveying path 30.

The sheet conveying device 3 includes a sheet feeding mechanism 31, and a plurality of conveying roller pairs 32.

The sheet feeding mechanism 31 feeds a sheet 9 in the sheet storing portion 2 to the sheet conveying path 30. The conveying roller pairs 32 convey the sheet 9 along the sheet conveying path 30. Further, one of the conveying roller pairs 32 discharges the sheet 9 from the sheet conveying path 30 onto a discharge tray 101.

The printing device 4 executes the print processing on the sheet 9 conveyed along the sheet conveying path 30. In the present embodiment, the printing device 4 is a tandem type color printing device.

The printing device 4 forms a toner image on the sheet 9 conveyed along the sheet conveying path 30. The toner image is an image using toner as a developer. The toner is granular and is an example of the developer.

The printing device 4 includes a plurality of monochromatic image forming portions 4x, a laser scanning unit 40, a transfer device 44, and a fixing device 46. In the present embodiment, the printing device 4 includes four monochromatic image forming portions 4x corresponding to four colors of yellow, cyan, magenta, and black.

The monochromatic image forming portions 4x each include a drum-shaped photoconductor 41, a charging device 42, a developing device 43, a drum cleaning device 45, and the like.

In each of the monochromatic image forming portions 4x, the photoconductor 41 rotates, and the charging device 42 executes charging processing. The charging processing is processing for charging the surface of the photoconductor 41. Further, the laser scanning unit 40 forms an electrostatic latent image on the charged surface of the photoconductor 41 by scanning with a laser beam.

The laser scanning unit 40 is an example of a latent image forming portion for forming the electrostatic latent image on the charged surface of the photoconductor 41.

Furthermore, the developing device 43 supplies the toner to the surface of the photoconductor 41 to develop the electrostatic latent image into the toner image. The developing device 43 supplies the toner to the photoconductor 41 at a developing position on the outer periphery of the photoconductor 41. The developing device 43 is an example of a developing portion.

The charging device 42 includes a charging member 421 and a charging voltage output device 422. The charging member 421 is disposed at a charging position on the outer periphery of the photoconductor 41 so as to face the photoconductor 41. The charging voltage output device 422 applies a charging bias voltage to the charging member 421. The charging bias voltage is a bias voltage applied in the charging processing.

The charging bias voltage is applied to the photoconductor 41 from the charging voltage output device 422 through the charging member 421. Thus, the surface of the photoconductor 41 is charged. The charging device 42 is an example of a charging portion.

The developing device 43 includes a developing roller 431 and a developing voltage output device 432. The developing roller 431 is disposed at the developing position so as to face the photoconductor 41. The developing roller 431 rotates while carrying toner.

The developing voltage output device 432 applies a developing bias voltage to the developing roller 431. In the present embodiment, the developing bias voltage is a voltage obtained by superimposing an AC voltage on a DC voltage.

The developing roller 431 rotates while carrying toner, and supplies the toner to the surface of the photoconductor 41 at the developing position. The developing roller 431 is an example of a developing member. The developing voltage output device 432 is an example of a developing voltage output portion.

The toner carried on the developing roller 431 is transferred to the portion of the electrostatic latent image on the surface of the photoconductor 41 due to the electric field generated between the developing roller 431 and the photoconductor 41.

At the developing position, the toner is transferred from the developing roller 431 to the portion of the electrostatic latent image on the surface of the photoconductor 41. Thus, the electrostatic latent image is developed into the toner image. Each of the four photoconductors 41 is an example of an image carrier that carries the toner image.

As described above, the laser scanning unit 40 and each of the four monochromatic image forming portions 4x can form the toner image on the surface of the photoconductor 41. The laser scanning unit 40 and each of the four monochromatic image forming portions 4x are an example of an image forming portion.

In the present embodiment, the developing device 43 performs development using a two-component development method. That is, the developing device 43 stirs a two-component developer containing the toner and a magnetic carrier to charge the toner. Further, the developing device 43 supplies the charged toner to the photoconductor 41.

The magnetic carrier is a granular material having magnetism. For example, the magnetic carrier is a granular magnetic material with a coated surface. The coating is made of a synthetic resin such as an epoxy resin.

The transfer device 44 includes an intermediate transfer belt 441, four primary transfer devices 442 corresponding to the four monochromatic image forming portions 4x, a secondary transfer device 443, and a belt cleaning device 444.

The intermediate transfer belt 441 is supported by a plurality of support rollers 440. One of the support rollers 440 is rotated by power received from a motor (not shown). Thus, the intermediate transfer belt 441 rotates.

Each of the photoconductors 41 is in contact with the intermediate transfer belt 441 at a primary transfer position on the outer periphery of the photoconductor 41.

Each primary transfer device 442 can execute primary transfer processing. The primary transfer processing is processing for transferring the toner image on the surface of the photoconductor 41 to the surface of the intermediate transfer belt 441.

When a plurality of primary transfer devices 442 perform the primary transfer processing, the toner images of a plurality of colors are formed on the surface of the intermediate transfer belt 441.

Each primary transfer device 442 includes a primary transfer member 4421 and a primary voltage output device 4422. The primary transfer member 4421 is disposed so as to face the photoconductor 41 with the intermediate transfer belt 441 interposed therebetween.

The primary voltage output device 4422 applies a primary transfer bias voltage to the primary transfer member 4421. The toner image formed on the surface of the photoconductor 41 is transferred to the surface of the intermediate transfer belt 441 by the electric field generated between the photoconductor 41 and the primary transfer member 4421. The polarity of the primary transfer bias voltage is opposite to the charge polarity of the toner.

The secondary transfer device 443 can execute secondary transfer processing. The secondary transfer processing is processing for transferring the toner image formed on the intermediate transfer belt 441 to a sheet 9 at a secondary transfer position of the sheet conveying path 30.

The secondary transfer device 443 includes a secondary transfer member 4431 and a secondary voltage output device 4432. The secondary transfer member 4431 is in contact with the intermediate transfer belt 441 at the secondary transfer position. The sheet 9 passes between the intermediate transfer belt 441 and the secondary transfer member 4431.

The secondary voltage output device 4432 applies a secondary transfer bias voltage to the secondary transfer member 4431. The toner image formed on the surface of the intermediate transfer belt 441 is transferred to the sheet 9 by the electric field generated between the intermediate transfer belt 441 and the secondary transfer member 4431. The polarity of the secondary transfer bias voltage is opposite to the charge polarity of the toner.

It is noted that the intermediate transfer belt 441 is an example of an intermediate transfer member. The transfer device 44 is an example of a transfer portion capable of executing the primary transfer processing and the secondary transfer processing.

The drum cleaning device 45 executes toner recovery processing. The toner recovery processing is processing for recovering toner present on the portion of the surface of the photoconductor 41 that has passed through the primary transfer position.

Further, the drum cleaning device 45 can also execute toner release processing. The toner release processing is processing for releasing toner recovered from the surface of the photoconductor 41 to the surface of the photoconductor 41. The drum cleaning device 45 is an example of a cleaning portion.

The drum cleaning device 45 includes a recovery member 451 and a recovery voltage output device 452. The recovery member 451 is a member capable of retaining the toner. For example, the recovery member 451 is a porous member such as a sponge.

The recovery member 451 rotates while being in contact with the surface of the photoconductor 41. The recovery member 451 is in contact with the surface of the photoconductor 41 at a recovery position on the outer periphery of the photoconductor 41. The recovery position is a position between the primary transfer position and the charging position on the outer periphery of the photoconductor 41.

The recovery voltage output device 452 can apply a recovery bias voltage or a release bias voltage to the recovery member 451. The recovery voltage output device 452 is an example of a recovery voltage output portion.

The recovery bias voltage is a voltage having a polarity different from the charge polarity of the toner. The release bias voltage is a voltage having the same polarity as the charge polarity of the toner.

The recovery voltage output device 452 applies the recovery bias voltage to the recovery member 451 in the toner recovery processing. Thus, the toner on the surface of the photoconductor 41 is electrically attracted to the recovery member 451 and retained in the recovery member 451. The toner recovered by the recovery member 451 is accumulated in a plurality of pores formed on the surface of the recovery member 451.

On the other hand, the recovery voltage output device 452 applies the release bias voltage to the recovery member 451 in the toner release processing. Thus, the toner retained in the recovery member 451 is electrically attracted to the surface of the photoconductor 41, and released from the recovery member 451 to the surface of the photoconductor 41.

When the print processing is executed, the recovery processing is executed. By executing the recovery processing, the toner that has not been transferred to the intermediate transfer belt 441 at the primary transfer position is recovered by the recovery member 451.

However, as toner is accumulated in the recovery member 451, the toner recovery performance of the recovery member 451 is deteriorated.

On the other hand, when a predetermined release condition is satisfied while the print processing is not being executed, the release processing is executed. By performing the release processing, the toner recovery performance of the recovery member 451 is improved.

In the present embodiment, the developing voltage output device 432 can also output an attraction bias voltage to the developing roller 431. The attraction bias voltage is a voltage having a polarity different from the charge polarity of the toner.

When the release processing is executed, the developing voltage output device 432 applies the attraction bias voltage to the developing roller 431. Thus, the toner released from the recovery member 451 is recovered by the developing roller 431 to the developing device 43.

The belt cleaning device 444 removes the toner remaining on the portion of the intermediate transfer belt 441 that has passed through the secondary transfer position.

The fixing device 46 heats and presses the toner image on the sheet 9. Thus, the fixing device 46 fixes the toner image on the sheet 9.

The operation device 801 is a device for receiving an operation by a person. For example, the operation device 801 includes an operation button and a touch panel.

The display device 802 is a device for displaying information. For example, the display device 802 includes a panel display device, such as a liquid crystal display unit.

The image forming apparatus 10 further includes a density sensor 5 (see FIG. 1). The density sensor 5 detects the density of the toner image on the portion of the surface of the intermediate transfer belt 441 that has passed through the secondary transfer position.

The density sensor 5 detects the density of the toner image at a position between the secondary transfer position and the position of the belt cleaning device 444 on the outer periphery of the intermediate transfer belt 441.

For example, the density sensor 5 is a contact image sensor (CIS). The density sensor 5 is an example of a density detection portion for detecting the density of the toner image on the intermediate transfer member.

[Configuration of Control Device 8]

As shown in FIG. 2, the control device 8 includes a central processing unit (CPU) 81, a random access memory (RAM) 82, a secondary storage device 83, a signal interface 84, a communication device 85, and the like.

The secondary storage device 83 is a computer-readable nonvolatile storage device. The secondary storage device 83 can store and update computer programs and various types of data. For example, one or both of a flash memory and a hard disk drive are employed as the secondary storage device 83.

The signal interface 84 converts signals output from various sensors into digital data, and transmits the converted digital data to the CPU 81. Further, the signal interface 84 converts the control command output from the CPU 81 into a control signal, and transmits the control signal to the device to be controlled.

The communication device 85 executes communication with another device such as a host device (not shown). The CPU 81 communicates with the other device through the communication device 85.

The CPU 81 is a processor that executes various types of data processing and control by executing the computer programs. The control device 8 including the CPU 81 controls the sheet conveying device 3, the printing device 4, the display device 802, the communication device 85, and the like.

The RAM 82 is a computer-readable volatile storage device. The RAM 82 temporarily stores the computer programs to be executed by the CPU 81 and data to be output and referred to while the CPU 81 is executing various types of processing.

The CPU 81 includes a plurality of processing modules implemented by executing the computer programs. The processing modules include a main processing portion 8a, a job control potion 8b, an adjustment control portion 8c, and the like.

The main processing portion 8a executes processing for starting various types of processing according to an operation on the operation device 801, control of the display device 802, and the like.

The job control portion 8b controls the sheet conveying device 3. Thus, the job control portion 8b controls the feeding of the sheet 9 from the sheet storing portion 2 and the conveyance of the sheet 9 on the sheet conveying path 30.

Further, the job control portion 8b controls the printing device 4. The job control portion 8b causes the printing device 4 to execute the printing processing in synchronization with the conveyance of the sheet 9 by the sheet conveying device 3.

The adjustment control portion 8c determines whether or not the release condition is satisfied while the printing processing is not being executed. For example, the release condition is a condition that is satisfied each time the number of page prints reaches a predetermined number. The page print is the print processing on one page of the sheet 9.

Further, the adjustment control portion 8c executes refresh control when it determines that the release condition is satisfied.

The adjustment control portion 8c causes the drum cleaning device 45 to execute the toner release processing in the refresh control.

Further, the adjustment control portion 8c causes the developing voltage output device 432 to output the attraction bias voltage in the refresh control.

In contrast, the adjustment control portion 8c does not cause the charging voltage output device 422 to output a voltage or cause the laser scanning unit 40 to form the electrostatic latent image in the refresh control.

In the meanwhile, as the toner recovery and the toner release by the recovery member 451 are repeated, the toner recovery performance of the recovery member 451 gradually deteriorates. When the performance of the recovery member 451 is deteriorated, useless toner may remain on the surface of the photoconductor 41.

FIG. 5 is a graph showing the relationship between the test image density and the remaining toner density under three measurement conditions in the image forming apparatus 10. The horizontal axis of the graph represents the test image density, and the vertical axis of the graph represents the remaining toner density.

The test image density is the density of a test image formed on the surface of the photoconductor 41. The test image density is the density in image data representing the test image.

The remaining toner density is the density of the toner remaining on the surface of the photoconductor 41 when the recovery processing is executed for the test image.

Specifically, when the test image is formed on the surface of the photoconductor 41, the primary transfer device 442 executes the primary transfer processing on the toner on the area on the surface of the photoconductor 41 where the test image was formed.

Further, the density sensor 5 detects the density of the toner transferred to the area on the surface of the intermediate transfer belt 441 corresponding to the area where the test image was formed. The density detected by the density sensor 5 at this time is the remaining toner density.

It is noted that when the density sensor 5 detects the density after the test image is formed, the secondary voltage output device 4432 does not output the secondary transfer bias voltage.

The first measurement condition of the three measurement conditions is a condition that a reference recovery voltage was applied to the recovery member 451 as the recovery bias voltage in an initial state of the image forming apparatus 10.

The second measurement condition of the three measurement conditions is a condition that the reference recovery voltage was applied to the recovery member 451 as the recovery bias voltage in a load test state of the image forming apparatus 10. The load test state is a state after the page print accompanied by the toner recovery processing and the toner release processing have been performed a predetermined number of times each from the initial state.

The third measurement condition of the three measurement conditions is a condition that a correction recovery voltage is applied to the recovery member 451 as the recovery bias voltage in the load test state of the image forming apparatus 10. The correction recovery voltage is a bias voltage larger than the reference recovery voltage.

In FIG. 5, first measurement data D11, second measurement data D12, and third measurement data D13 are data of remaining toner densities corresponding to test image densities, respectively.

The first measurement data D11 is data under the first measurement condition, the second measurement data D12 is data under the second measurement condition, and the third measurement data D13 is data under the third measurement condition.

The difference between the first measurement data D11 and the second measurement data D12 indicates that the toner recovery performance of the recovery member 451 is deteriorated by repeating the toner recovery processing and the toner release processing.

The difference between the second measurement data D12 and the third measurement data D13 indicates that the deteriorated performance of the recovery member 451 can be compensated for by correcting the recovery bias voltage.

The remaining toner on the surface of the photoconductor 41 causes poor print quality. In contrast, when the performance of the recovery member 451 is correctly evaluated, the deteriorated performance of the recovery member 451 can be compensated for by correcting a control parameter such as the recovery bias voltage.

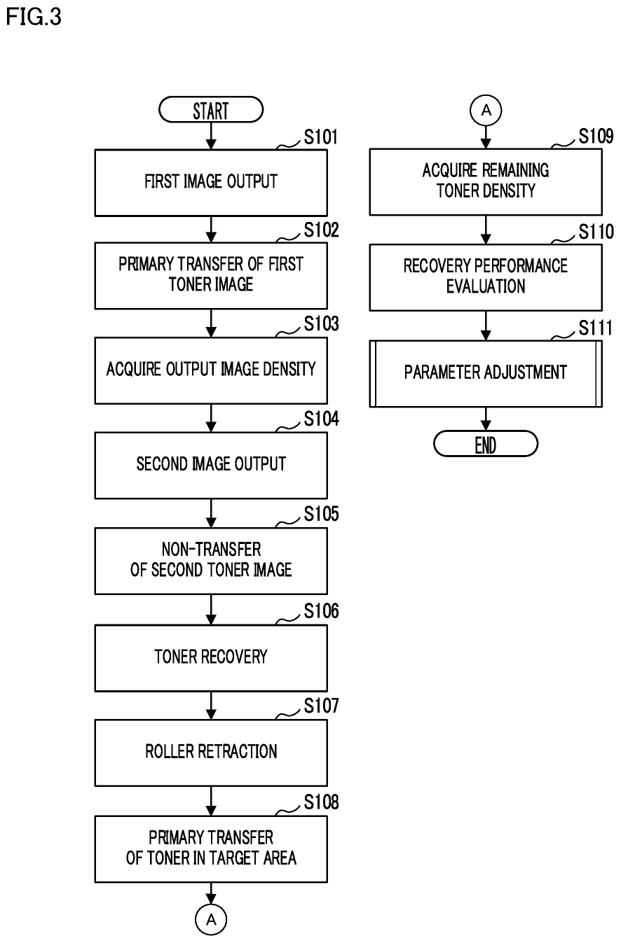

In the image forming apparatus 10, the adjustment control portion 8c can execute toner recovery adjustment processing (see FIG. 3). Thus, the performance of the recovery member 451 for recovering the toner on the surface of the photoconductor 41 is correctly evaluated. Further, the control parameter is corrected in accordance with the evaluation result of the performance of the recovery member 451.

[Toner Recovery Adjustment Processing]

The adjustment control portion 8c executes the toner recovery adjustment processing when a predetermined adjustment condition is satisfied while the print processing is not being executed. The adjustment control portion 8c executes the toner recovery adjustment processing for each of the monochromatic image forming portions 4x.

The adjustment control portion 8c determines whether or not the adjustment condition is satisfied while the print processing is not being executed. For example, the adjustment condition includes one or both of a print count condition and a remaining toner condition.

The print count condition is a condition that the number of the page prints has reached a predetermined number with reference to a point in time when the image forming apparatus 10 was started to be used or a point in time when the previous toner recovery adjustment processing was executed.

The remaining toner condition is a condition that the density detected by the density sensor 5 when the print processing was executed has exceeded an allowable density.

An example of the procedure of the toner recovery adjustment processing will be described below with reference to the flowchart shown in FIG. 3.

It is noted that the toner recovery adjustment processing is an example of processing for realizing the control method of the image forming apparatus 10. The CPU 81 is an example of a processor that realizes the control method of the image forming apparatus 10.

In the following description, S101, S102, . . . represent identification codes of a plurality of steps in the toner recovery adjustment processing. In the toner recovery adjusting processing, the process of step S101 is executed first.

<Step S101>

In step S101, the adjustment control portion 8c causes the monochromatic image forming portions 4x and the laser scanning unit 40 to execute first image output processing.

The first image output processing is processing for forming a first toner image on the surface of the photoconductor 41. For example, the first toner image is a patch image having a predetermined density.

After executing the process of step S101, the adjustment control portion 8c shifts the processing to step S102.

<Step S102>

In step S102, the adjustment control portion 8c causes the primary transfer device 442 to execute the primary transfer processing for the first toner image.

Specifically, the adjustment control portion 8c causes the primary voltage output device 4422 to output the primary transfer bias voltage when the first toner image passes through the primary transfer position.

After executing the process of step S102, the adjustment control portion 8c shifts the processing to step S103.

<Step S103>

In step S103, the adjustment control portion 8c acquires an output image density from the density sensor 5. The output image density is the density detected by the density sensor 5 for the first toner image.

Specifically, the adjustment control portion 8c acquires, as the output image density, the density detected by the density sensor 5 when the first toner image passes through the position of the density sensor 5.

It is noted that while the toner recovery adjustment processing is being executed, the adjustment control portion 8c does not cause the secondary voltage output device 4432 to output the secondary transfer bias voltage. For example, the adjustment control portion 8c causes the secondary voltage output device 4432 to output a bias voltage having a polarity opposite to that of the secondary transfer bias voltage. Thus, the toner transferred to the intermediate transfer belt 441 is removed by the belt cleaning device 444 after passing through the secondary transfer position and the position of the density sensor 5.

In addition, while the toner recovery adjustment processing is being executed, the adjustment control portion 8c may cause the secondary voltage output device 4432 to output a bias voltage having the same polarity as the charge polarity of the toner.

After executing the process of step S103, the adjustment control portion 8c shifts the processing to step S104.

<Step S104>

In step S104, the adjustment control portion 8c causes the monochromatic image forming portions 4x and the laser scanning unit 40 to execute second image output processing.

The second image output processing is processing for forming a second toner image on the surface of the photoconductor 41. The second toner image is the same toner image as the first toner image.

After executing the process of step S104, the adjustment control portion 8c shifts the processing to step S105.

<Step S105>

In step S105, the adjustment control portion 8c causes the primary transfer device 442 to execute non-transfer processing in which the second toner image is not transferred to the intermediate transfer belt 441.

Specifically, in step S105, the adjustment control portion 8c causes the primary voltage output device 4422 to output a bias voltage having the same polarity as the charge polarity of the toner.

After executing the process of step S105, the adjustment control portion 8c shifts the processing to step S106.

<Step S106>

In step S106, the adjustment control portion 8c causes the drum cleaning device 45 to execute the toner recovery processing when the second toner image passes through the recovery member 451.

By executing the process of step S106, the toner constituting the second toner image is retained in the recovery member 451.

In the following description, the area on the surface of the photoconductor 41 where the second toner image was formed will be referred to as a primary target area.

After executing the process of step S106, the adjustment control portion 8c shifts the processing to step S107.

<Step S107>

In step S107, the adjustment control portion 8c executes a roller retraction control when the primary target area passes the developing position.

In the present embodiment, the developing device 43 includes a roller moving mechanism 433 for moving the developing roller 431 from an operating position to a retracted position (see FIG. 1).

The operating position is a position where toner can be supplied from the developing roller 431 to the photoconductor 41. The retracted position is a position farther from the photoconductor 41 than the operating position. When the developing roller 431 is at the retracted position, toner does not move between the photoconductor 41 and the developing roller 431.

For example, the roller moving mechanism 433 includes a motor and a cam mechanism driven by the motor. The cam mechanism is a mechanism for moving the developing roller 431 between the operating position and the retracted position.

The roller retraction control is a control for causing the roller moving mechanism 433 to execute an operation for moving the developing roller 431 from the operating position to the retraction position.

After executing the process of step S107, the adjustment control portion 8c shifts the processing to step S108.

It is noted that the developing device 43 may include a carrier holding mechanism instead of the roller moving mechanism 433. The carrier holding mechanism includes a cylinder, a magnet contained in the cylinder, and a magnet moving mechanism.

The cylinder is disposed in the developing device 43 so as to face the developing roller 431. The magnet moving mechanism moves the magnet between a near position and a far position.

In step S108, the adjustment control portion 8c controls the magnet moving mechanism to hold the magnet at the near position.

At the near position, the magnet attracts the magnetic carrier carried by the developing roller 431, together with the toner. Thus, the magnetic carrier and the toner carried by the developing roller 431 are not conveyed to the developing position, but are held between the developing roller 431 and the cylinder. As a result, the released toner passes through the developing position without coming into contact with the magnetic carrier.

In contrast, when the development is performed by the developing device 43, the adjustment control portion 8c controls the magnet moving mechanism to hold the magnet at the far position. The far position is a position farther from the developing roller 431 than the near position. When the magnet is at the far position, the magnetic carrier and the toner carried by the developing roller 431 are conveyed to the developing position.

<Step S108>

In step S108, the adjustment control portion 8c causes the primary transfer device 442 to execute the primary transfer processing for the toner on the primary target area on the surface of the photoconductor 41.

Specifically, the adjustment control portion 8c causes the primary voltage output device 4422 to output the primary transfer bias voltage when the primary target area on the surface of the photoconductor 41 passes through the primary transfer position.

In the following description, the area on the surface of the intermediate transfer belt 441 corresponding to the primary target area will be referred to as a secondary target area. The secondary target area is an area to which toner on the primary target area is transferred.

After executing the process of step S108, the adjustment control portion 8c shifts the processing to step S109.

<Step S109>

In step S109, the adjustment control portion 8c acquires the remaining toner density from the density sensor 5. The remaining toner density is the density detected by the density sensor 5 for the toner on the secondary target area on the surface of the intermediate transfer belt 441.

Specifically, the adjustment control portion 8c acquires, as the remaining toner density, the density detected by the density sensor 5 when the secondary target area passes through the position of the density sensor 5.

After executing the process of step S109, the adjustment control portion 8c shifts the processing to step S110.

<Step S110>

In step S110, the adjustment control portion 8c executes recovery performance evaluation processing. The recovery performance evaluation processing is processing for deriving an index value of the toner recovery performance of the recovery member 451 by comparing the output image density with the remaining toner density.

For example, the index value is a difference between the output image density and the remaining toner density or a ratio of the remaining toner density to the output image density.

After executing the process of step S110, the adjustment control portion 8c shifts the processing to step S111.

<Step S111>

In step S111, the adjustment control portion 8c executes parameter adjustment processing based on the index value of the toner recovery performance. The parameter adjustment processing will be described later.

The adjustment control portion 8c terminates the toner recovery adjustment processing after executing the process of step S111.

[Parameter Adjustment Processing]

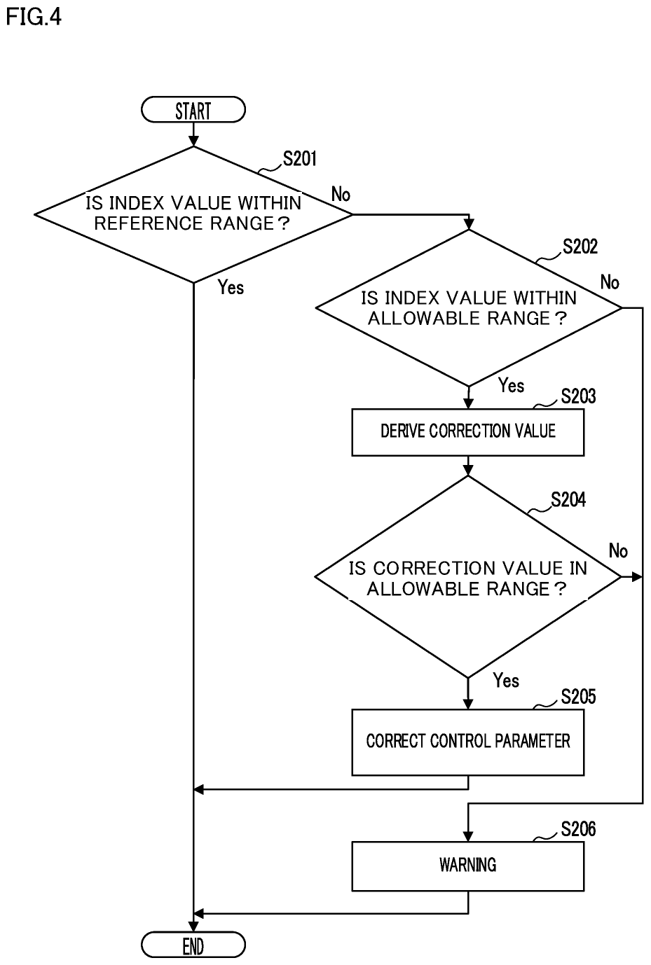

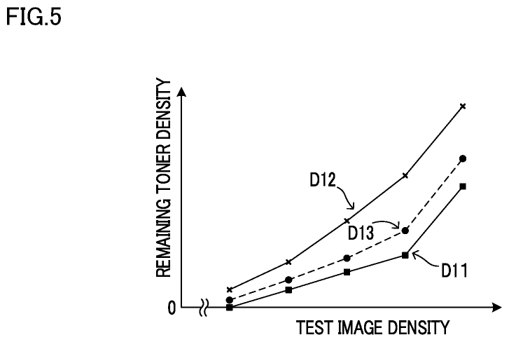

Next, an example of the procedure of the parameter adjustment processing will be described with reference to the flowchart shown in FIG. 4.

In the following description, S201, S202, . . . represent identification codes of a plurality of steps in the parameter adjustment processing. In the parameter adjustment processing, the process of step S201 is executed first.

<Step S201>

In step S201, the adjustment control portion 8c determines whether the index value of the toner recovery performance is within a predetermined reference range or out of the reference range.

When the adjustment control portion 8c determines that the index value is within the reference range, the adjustment control portion 8c terminates the parameter adjustment processing.

On the other hand, when the adjustment control portion 8c determines that the index value is out of the reference range, the adjustment control portion 8c shifts the processing to step S202.

<Step S202>

In step S202, the adjustment control portion 8c determines whether the index value of the toner recovery performance is within a predetermined allowable range or out of the allowable range. The allowable range is wider than the reference range.

When the adjustment control portion 8c determines that the index value is within the allowable range, the adjustment control portion 8c shifts the processing to step S203.

On the other hand, when the adjustment control portion 8c determines that the index value is out of the allowable range, the adjustment control portion 8c shifts the processing to step S206.

<Step S203>

In step S203, the adjustment control portion 8c derives a correction value of one or more of control parameters in accordance with the index value of the toner recovery performance.

The control parameter includes one or more of the recovery bias voltage, the rotational speed of the recovery member 451, the primary transfer bias voltage, and the charging bias voltage.

As shown in FIG. 5, the toner recovery performance of the recovery member 451 is compensated for by correcting the recovery bias voltage to a larger bias voltage.

At the portion where the recovery member 451 comes into contact with the photoconductor 41, the surface of the recovery member 451 moves in the same direction as the moving direction of the surface of the photoconductor 41. By correcting the peripheral speed of the recovery member 451 to be slower than the peripheral speed of the photoconductor 41, the efficiency of toner recovery by the recovery member 451 is improved. That is, the toner recovery performance of the recovery member 451 is compensated for.

In addition, by correcting the primary transfer bias voltage to a larger bias voltage, the amount of toner remaining on the surface of the photoconductor 41 is reduced. Thus, the toner recovery performance of the recovery member 451 is compensated for. It is noted that the primary transfer bias voltage is a bias voltage applied in the primary transfer processing.

In addition, by correcting the charging bias voltage to a larger bias voltage, the amount of toner remaining on the surface of the photoconductor 41 is reduced. Thus, the toner recovery performance of the recovery member 451 is compensated for.

After executing the process of step S203, the adjustment control portion 8c shifts the processing to step S204.

<Step S204>

In step S204, the adjustment control portion 8c determines whether the correction value derived in step S204 is within a predetermined correction allowable range or out of the correction allowable range.

When the adjustment control portion 8c determines that the correction value is within the correction allowable range, the adjustment control portion 8c shifts the processing to step S205. On the other hand, when the adjustment control portion 8c determines that the correction value is out of the correction allowable range, the adjustment control portion 8c shifts the processing to step S206.

<Step S205>

In step S205, the adjustment control portion 8c corrects the control parameter in accordance with the correction value derived in step S203.

The adjustment control portion 8c terminates the parameter adjustment processing after executing the process of step S205.

<Step S206>

In step S206, the adjustment control portion 8c executes warning processing to prompt replacement of the recovery member 451. For example, the warning processing is processing for causing the display device 802 to display a predetermined message.

The process of step S206 is executed when the correction value of the control parameter or the index value is out of the allowable range. The adjustment control portion 8c terminates the parameter adjustment processing after executing the process of step S206.

By executing the toner recovery adjustment processing, the performance of the recovery member 451 is correctly evaluated. As a result, the deteriorated performance of the recovery member 451 is compensated for by executing the parameter adjustment processing.

In addition, the adjustment control portion 8c may execute the processes of steps S101 to S109 a plurality of times under a plurality of output density conditions in which the density of each of the first toner image and the second toner image varies. For example, the output density condition is the number of drawing pixels in each of the first toner image and the second toner image. In addition, the output density condition may be the light intensity of the beam light of the laser scanning unit 40.

Executing the processes of steps S101 to S109 a plurality of times includes causing the monochromatic image forming portions 4x and the laser scanning unit 40 to execute the first image output processing and the second image output processing a plurality of times (see steps S102 and S104).

In addition, executing the processes of steps S101 to S109 a plurality of times includes causing the transfer device 44 to execute the primary transfer processing for the first toner image a plurality of times, the non-transfer processing for the second toner image a plurality of times, and the primary transfer processing for the toner on the target area a plurality of times (see steps S102, S105, and S108).

When the processes of steps S101 to S109 are executed under the plurality of output density conditions, a plurality of pairs of the output image density and the remaining toner density are acquired corresponding to the plurality of output density conditions.

In the above case, in step S110, the adjustment control portion 8c may derive the index value of the recovery performance based on the plurality of pairs of the output image density and the remaining toner density.

For example, the adjustment control portion 8c derives a plurality of index value candidates corresponding to the plurality of pairs of the output image density and the remaining toner density. In this case, the adjustment control portion 8c derives a representative value of the index value candidates as the index value. The representative value is, for example, an average value, a weighted average value, a maximum value, or a minimum value.

In addition, the adjustment control portion 8c may execute the processes of steps S101 to S110 in the initial state of the image forming apparatus 10. In this case, the adjustment control portion 8c stores the initial index value acquired in step S110 in the secondary storage device 83 as a reference value.

In step S110 of the toner recovery adjustment processing, the adjustment control portion 8c may derive a comparison value by comparing the output image density with the remaining toner density.

Further, the adjustment control portion 8c may derive a difference or ratio between the comparison value and the reference value as the index value. It is noted that the comparison value is a difference or ratio between the output image density and the remaining toner density.

Alternatively, the adjustment control portion 8c may set the reference range of the index value based on the reference value (see step S201 in FIG. 4).

In addition, the developing device 43 may be an interactive touchdown developing device or a jumping developing device. In this case, the developing device 43 does not include the roller moving mechanism 433. In step S108 of the toner recovery adjustment processing, the adjustment control portion 8c does not cause the developing voltage output device 432 to output a voltage.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A control method of an image forming apparatus, wherein
the image forming apparatus includes:
an image forming portion including a rotary photoconductor and capable of forming a toner image on a surface of the photoconductor;
a transfer portion including a rotary intermediate transfer member and capable of executing primary transfer processing for transferring the toner image on the surface of the photoconductor to a surface of the intermediate transfer member at a primary transfer position and secondary transfer processing for transferring the toner image on the surface of the intermediate transfer member to a sheet at a secondary transfer position;
a cleaning portion capable of executing toner recovery processing for recovering toner present on a portion of the surface of the photoconductor that has passed through the primary transfer position; and
a density detection portion for detecting a density of the toner image on the intermediate transfer member,
the cleaning portion includes:
a recovery member configured to rotate while being in contact with the surface of the photoconductor and capable of retaining the toner; and
a recovery voltage output portion for applying a recovery bias voltage having a polarity different from a charge polarity of the toner to the recovery member in the toner recovery processing, and
the control method comprises:
causing, by a processor, the image forming portion to execute first image output processing for forming a first toner image on the surface of the photoconductor;
causing, the processor, the transfer portion to execute the primary transfer processing for the first toner image;
acquiring, by the processor, an output image density that is a density detected by the density detector for the first toner image;
causing, by the processor, the image forming portion to execute second image output processing for forming a second toner image identical to the first toner image on the surface of the photoconductor;
causing, by the processor, the transfer portion to execute non-transfer processing in which the second toner image is not transferred to the intermediate transfer member;
causing, by the processor, the cleaning portion to execute the toner recovery processing when the second toner image passes through the recovery member;
causing, by the processor, the transfer portion to execute the primary transfer processing for the toner on a target area on the surface of the photoconductor where the second toner image was formed;
acquiring, by the processor, a remaining toner density that is a density detected by the density detector for the toner on an area on the surface of the intermediate transfer member corresponding to the target area; and
deriving, by the processor, an index value of toner recovery performance of the recovery member by comparing the output image density with the remaining toner density.

2. The control method of the image forming apparatus according to claim 1, further comprising correcting, by the processor, one or more control parameters in accordance with the index value.

3. The control method of the image forming apparatus according to claim 2, wherein the control parameters include one or more of the recovery bias voltage, a rotational speed of the recovery member, a primary transfer bias voltage applied in the primary transfer processing by the transfer portion, and a charging bias voltage applied in charging processing of the surface of the photoconductor by the image forming portion.

4. The control method of the image forming apparatus according to claim 2, further comprising executing, by the processor, warning processing when a correction value of the control parameters or the index value is out of an allowable range.

5. The control method of the image forming apparatus according to claim 1, wherein
the processor causes the first image output processing and the second image output processing a plurality of times under a plurality of output density conditions in which the density of each of the first toner image and the second toner image varies,
the processor further causes the transfer portion to execute the primary transfer processing for the first toner image a plurality of times, the non-transfer processing for the second toner image a plurality of times, and the primary transfer processing for the toner on the target area a plurality of times under the plurality of output density conditions, and
the processor further derives the index value based on a plurality of pairs of the output image density and the remaining toner density acquired corresponding to the plurality of output density conditions.

6. An image forming apparatus comprising:
an image forming portion including a rotary photoconductor and capable of forming a toner image on a surface of the photoconductor;
a transfer portion including a rotary intermediate transfer member and capable of executing primary transfer processing for transferring the toner image on the surface of the photoconductor to a surface of the intermediate transfer member at a primary transfer position and secondary transfer processing for transferring the toner image on the surface of the intermediate transfer member to a sheet at a secondary transfer position;
a cleaning portion capable of performing toner recovery processing for recovering toner present on a portion of the surface of the photoconductor that has passed through the primary transfer position;
a density detection portion for detecting a density of the toner image on the intermediate transfer member; and
a processor for realizing the control method of the image forming apparatus according to claim 1, wherein
the cleaning portion includes:
a recovery member configured to rotate while being in contact with the surface of the photoconductor and capable of retaining the toner; and
a recovery voltage output portion for applying a recovery bias voltage having a polarity different from a charge polarity of the toner to the recovery member in the toner recovery processing.
